(19) United States
(12) Patent Application Publication
(10) Pub. No.: US 2025/0215709 A1
(43) Pub. Date: Jul. 3, 2025

(54) BINDING MACHINE

(71) Applicant: Max Co., Ltd., Tokyo (JP)

(72) Inventors: Yusuke Yoshida, Tokyo (JP); Shingo Takahashi, Tokyo (JP); Tetsuro Fukuda, Tokyo (JP)

(21) Appl. No.: 18/983,705

(22) Filed: Dec. 17, 2024

(30) Foreign Application Priority Data
Dec. 28, 2023 (JP) 2023-222766

(51) Int. Cl. E04G 21/12; B21F 15/04; B25B 25/00

(52) U.S. Cl. CPC E04G 21/123; B21F 15/04; B25B 25/00

(57) ABSTRACT

A binding machine includes a curl forming portion. The curl forming portion includes a curl guide configured to curl a plurality of wires. The curl guide includes a first wire guide configured to regulate positions of the wires directed toward a radially outer periphery side with respect to a radial direction of a annular feeding path, a second wire guide configured to regulate positions of the wires directed toward one axial side with respect to an axial direction of the annular feeding path, and a third wire guide configured to regulate positions of the wires directed toward the other axial side. The curl guide includes a suppression part configured to suppress one wire of the plurality of wires from moving in a direction toward another wire.

### CROSS-REFERENCE TO RELATED APPLICATIONS

This application is based on and claims priority under 35 USC § 119 from Japanese Patent Application No. 2023-222766 filed on Dec. 28, 2023, the contents of which are incorporated herein by reference.

### TECHNICAL FIELD

The present disclosure relates to a binding machine for binding a to-be-bound object, such as a reinforcing bar, with a wire.

### BACKGROUND ART

For concrete buildings, reinforcing bars are used so as to improve strength. The reinforcing bars are bound with wires so that the reinforcing bars do not deviate from predetermined positions during concrete placement.

In the related art, suggested is a binding machine referred to as a reinforcing bar binding machine configured to wind a wire on two or more reinforcing bars and to twist the wire wound on the reinforcing bars, thereby binding the two or more reinforcing bars with the wire.

When binding reinforcing bars with a wire, the reinforcing bars will become misaligned if the binding is loose. Therefore, it is required to bind and maintain the reinforcing bars tightly. By using a wire with a large diameter, it is possible to ensure the binding strength of the reinforcing bars. However, if a wire with a large diameter is used, the rigidity of the wire increases, so a greater force is required to bind the reinforcing bars.

Accordingly, a binding machine is proposed which includes a feeding means capable of feeding two or more wires and winding the wires around a to-be-bound object and a binding means for binding the to-be-bound object by gripping and twisting the two or more wires wound around the to-be-bound object by the feeding means, and the feeding means aligns the two or more wires in parallel in an axial direction of a wire feeding path having an annular shape and feeds the wires (for example, see Patent Literature 1).

Patent Literature 1: Japanese Patent No. 6791141B

In the binding machine that aligns two or more wires in parallel and feeds the wires, when one of the plurality of wires moves in a direction toward another wire in a curl guide, which curls the wires, it affects a posture of the wires in the air after being fed out from the curl guide. When the posture of the wires in the air varies, a landing position on an induction guide that guides the wires to the binding means also varies.

When a diameter of the reinforcing bars to be bound with the wire increases, it is necessary to increase a diameter of the feeding path of the wires that are wound in an annular shape around the reinforcing bars. However, the variation of the landing position on the induction guide increases as the diameter of the annular feeding path increases. For this reason, there is a possibility that the wires will not enter the induction guide. In contrast, if the induction guide is enlarged to ensure that the wires enter the induction guide, the binding machine may increase in size or weight, potentially leading to a deterioration of operability.

The present disclosure has been made in view of the above problems, and an object thereof is to provide a binding machine that can suppress one of a plurality of wires from moving in a direction toward another wire in a curl guide.

### SUMMARY OF INVENTION

An aspect of the present disclosure is a binding machine including: a wire feeding portion configured to feed a plurality of wires; a curl forming portion configured to form an annular feeding path for winding the plurality of wires fed by the wire feeding portion around a to-be-bound object; and a binding portion configured to twist the plurality of wires wound on the to-be-bound object. The curl forming portion includes a curl guide configured to curl the plurality of wires fed by the wire feeding portion, and an induction guide configured to guide the plurality of wires curled by the curl guide to the binding portion. The curl guide includes a first wire guide configured to regulate positions of the wires directed toward a radially outer periphery side with respect to a radial direction of the annular feeding path, a second wire guide configured to regulate positions of the wires directed toward one axial side with respect to an axial direction of the annular feeding path, and a third wire guide configured to regulate positions of the wires directed toward the other axial side. The curl guide includes a suppression part configured to allow the plurality of wires to be aligned in contact with each other between the second wire guide and the third wire guide along the axial direction of the annular feeding path, and to suppress one wire of the plurality of wires from moving in a direction toward another wire.

### BRIEF DESCRIPTION OF DRAWINGS

FIG. 1A is an internal configuration view showing an example of an overall configuration of a reinforcing bar binding machine of the present embodiment, as seen from a side.

FIG. 1B is an internal configuration view showing the example of the overall configuration of the reinforcing bar binding machine of the present embodiment, as seen from the front.

FIG. 1C is a side view showing the example of the overall configuration of the reinforcing bar binding machine of the present embodiment.

FIG. 2 is a side view showing an example of a curl guide, with some components removed.

FIG. 3A is a side view showing the example of the curl guide.

FIG. 3B is a cross-sectional view taken along line B-B of FIG. 3A.

FIG. 3C is a cross-sectional view taken along line C-C of FIG. 3A.

FIG. 3D is a top view showing the example of the curl guide.

FIG. 4 is a side view showing another example of the curl guide, with some components removed.

FIG. 5A is a side view showing another example of the curl guide.

FIG. 5B is a cross-sectional view taken along line D-D of FIG. 5A.

FIG. 6 is a side view showing a variation of another example of the curl guide, with some components removed.

FIG. 7 is a side view showing still another example of the curl guide, with some components removed.

FIG. 8A is a side view showing still another example of the curl guide.

FIG. 8B is a cross-sectional view taken along line E-E of FIG. 8A.

FIG. 8C is a cross-sectional view taken along line F-F of FIG. 8A.

### DESCRIPTION OF EMBODIMENTS

Hereinafter, an example of a reinforcing bar binding machine as an embodiment of the binding machine of the present disclosure will be described with reference to the drawings.

### Configuration Example of Reinforcing Bar Binding Machine of Present Embodiment

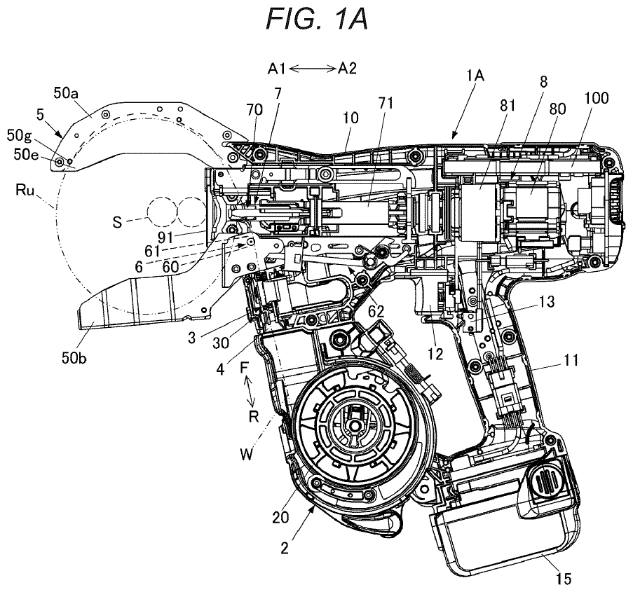

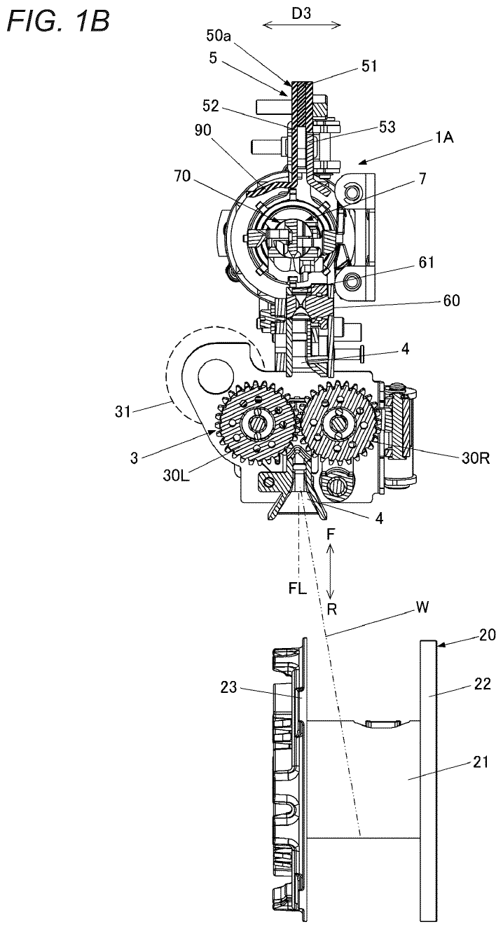

FIG. 1A is an internal configuration view showing an example of an overall configuration of a reinforcing bar binding machine of the present embodiment, as seen from a side, FIG. 1B is an internal configuration view showing the example of the overall configuration of the reinforcing bar binding machine of the present embodiment, as seen from the front, and FIG. 1C is a side view showing the example of the overall configuration of the reinforcing bar binding machine of the present embodiment.

A reinforcing bar binding machine 1A has such a shape that an operator grips with a hand, and includes a main body part 10 and a handle part 11. In addition, the reinforcing bar binding machine 1A feeds wires W in a forward direction indicated by an arrow F, winds the wires around reinforcing bars S, which are a to-be-bound object, feeds the wires W wound around the reinforcing bars S in a reverse direction indicated by an arrow R, winds the wires on the reinforcing bars S, and twists the wires W, thereby binding the reinforcing bars S with the wires W. The reinforcing bar binding machine 1A binds the reinforcing bars S with a plurality of wires W, in this example, two wires W.

In order to implement the above-described functions, the reinforcing bar binding machine 1A includes a magazine 2 in which the wires W are accommodated, a wire feeding portion 3 that aligns two wires W in a radial direction of the wires W and feeds the wires W at a time, and a wire guide portion 4 that guides the two wires W, which are fed by the wire feeding portion 3. In addition, the reinforcing bar binding machine 1A includes a curl forming portion 5 that forms an annular feeding path for winding the two wires W, which are fed by the wire feeding portion 3, around the reinforcing bars S once, and a cutting portion 6 that cuts the two wires W wound on the reinforcing bars S. In addition, the reinforcing bar binding machine 1A includes a binding portion 7 that twists the two wires W wound on the reinforcing bars S, and a drive portion 8 that drives the binding portion 7. Note that the annular feeding path along which the two wires W, which are fed by the wire feeding portion 3, are wound once around the reinforcing bars S, is a path along which wires are fed when winding two wires around a to-be-bound object at a time in a single turn.

The magazine 2 is an example of an accommodation portion, and a reel 20 on which the long wires W are wound to be reeled out is rotatably and detachably accommodated therein. For the wire W, a wire made of a plastically deformable metal wire, a wire having a metal wire covered with a resin, or a twisted wire is used.

The reel 20 includes a tubular hub part 21 on which the wires W are wound and a pair of flange parts 22 and 23 integrally provided on both axial end sides of the hub part 21. The flange parts 22 and 23 have a substantially circular plate shape with a larger diameter than that of the hub part 21 and are provided concentrically with the hub part 21. The reel 20 is configured such that two wires W are wound on the hub part 21 and two wires W are pulled out from the reel 20 simultaneously.

As shown in FIG. 1B, in the reinforcing bar binding machine 1A, the reel 20 is attached in a state of being offset in one direction along an axial direction of the hub part 21 with respect to a feeding path FL of the wires W, which is defined by the wire feeding portion 3, the wire guide portion 4, and the like.

The wire feeding portion 3 includes a pair of feeding gears 30 (30L, 30R) that sandwiches and feeds the two wires W aligned in parallel. In the wire feeding portion 3, a rotating operation of a feeding motor 31 is transmitted to one feeding gear 30L. Additionally, engagement of gear portions provided on outer peripheries of the feeding gear 30L and the feeding gear 30R transmits a rotating operation of one feeding gear 30L to the other feeding gear 30R. Thereby, one feeding gear 30L becomes a driving side, and the other feeding gear 30R becomes a driven side.

The wire feeding portion 3 aligns two wires W in parallel along a direction in which the pair of feeding gears 30L and 30R is aligned. In the wire feeding portion 3, one wire W comes into contact with a groove portion of one feeding gear 30L, the other wire W comes into contact with a groove portion of the other feeding gear 30R, and one wire W and the other wire W come into contact with each other. Thereby, the wire feeding portion 3 feeds two wires W, sandwiched between the pair of feeding gears 30 (30L, 30R), along an extension direction of the wires W by a frictional force generated between one feeding gear 30L and one wire W, a frictional force generated between the other feeding gear 30R and the other wire W, and a frictional force generated between the two wires W as the pair of feeding gears 30 (30L, 20 30R) rotates.

Additionally, in the wire feeding portion 3, a rotation direction of the feeding motor 31 is switched between forward and reverse directions to switch a rotation direction of the feeding gears 30, thereby switching a feeding direction of the wires W between the forward and reverse directions.

The wire guide portion 4 is arranged on upstream and downstream sides of the feeding gears 30 with respect to the feeding direction of the wires W that are fed in the forward direction. The wire guide portion 4 aligns the two entering wires W in parallel along the direction in which the pair of feeding gears 30 is aligned and guides the same between the pair of feeding gears 30.

The wire guide portion 4 is configured such that an opening area of an opening on the upstream side with respect to the feeding direction of the wires W, which are fed in the forward direction, is larger than that of an opening on the downstream side, and a part or all of an inner surface of the opening is tapered. This can facilitate an operation of inserting the wires W pulled out from the reel 20 accommodated in the magazine 2 into the wire guide portion 4.

The curl forming portion 5 includes a curl guide 50a that curls two wires W, which are fed by the wire feeding portion 3, and regulates movement of each wire W in a direction in which the two wires W are aligned in parallel, and an induction guide 50b that guides the two wires W curled by the curl guide 50a to the binding portion 7. The curl forming portion 5 forms an annular feeding path Ru, indicated by a two-dot chain line in FIG. 1A, passing through the induction guide 50b from the curl guide 50a and reaching the binding portion 7 by curling the two wires W that are fed by the wire feeding portion 3 and pass through the curl guide 50a. The curl guide 50a suppresses one wire W of the two wires W from moving in a direction toward the other wire. Additionally, the curl guide 50a suppresses the other wire W from moving in a direction toward one wire by one wire W of the two wires W. Thereby, the curl guide 50a suppresses the order of alignment of the two wires W, which are fed by the wire feeding portion 3 so as to be aligned along the axial direction of the annular feeding path Ru, from being switched.

The cutting portion 6 includes a fixed blade part 60, a movable blade part 61 that cuts the wires W in cooperation with the fixed blade part 60, and a transmission mechanism 62 that transmits an operation of the binding portion 7 to the movable blade part 61.

The binding portion 7 includes a wire locking body 70 to which the wires W are locked, and a sleeve 71 for actuating the wire locking body 70. The drive portion 8 includes a twist motor 80 and a decelerator 81 that performs deceleration and torque amplification.

The reinforcing bar binding machine 1A includes a feeding regulation part 90, against which tips of the wires W are butted, at a terminal end of the feeding path of the wires W, which pass through the annular feeding path Ru and are locked by the wire locking body 70. Additionally, in the reinforcing bar binding machine 1A, the curl guide 50a and the induction guide 50b of the curl forming portion 5 are provided at an end portion on a front side of the main body part 10. Additionally, in the reinforcing bar binding machine 1A, a butting portion 91, against which the reinforcing bars S are butted, is provided between the curl guide 50a and the induction guide 50b at the end portion on the front side of the main body part 10.

In the reinforcing bar binding machine 1A, the handle part 11 extends downward from the main body part 10. In addition, a battery 15 is detachably mounted to a lower part of the handle part 11. In addition, in the reinforcing bar binding machine 1A, the magazine 2 is provided in front of the handle part 11.

In the reinforcing bar binding machine 1A, a trigger 12 is provided on a front side of the handle part 11, and a switch 13 is provided inside the handle part 11. In the reinforcing bar binding machine 1A, a control portion 100 controls the feeding motor 31 and the twist motor 80, in response to a state of the switch 13 that is pressed by an operation on the trigger 12.

### Configuration Example of Main Parts of Reinforcing Bar Binding Machine of Present Embodiment

### Configuration Example of Curl Guide

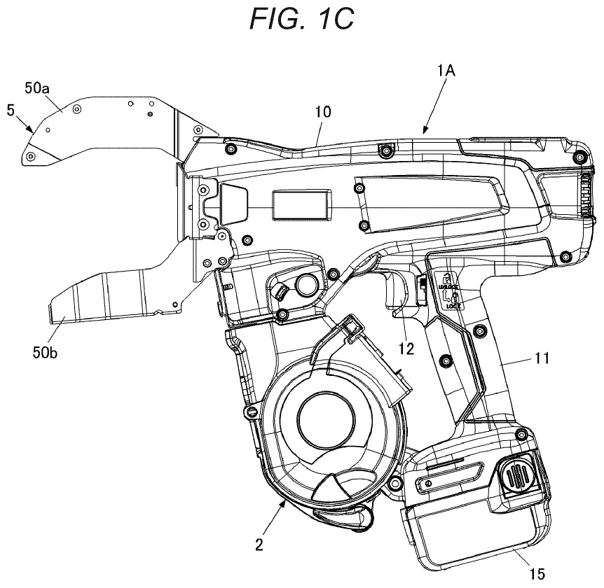

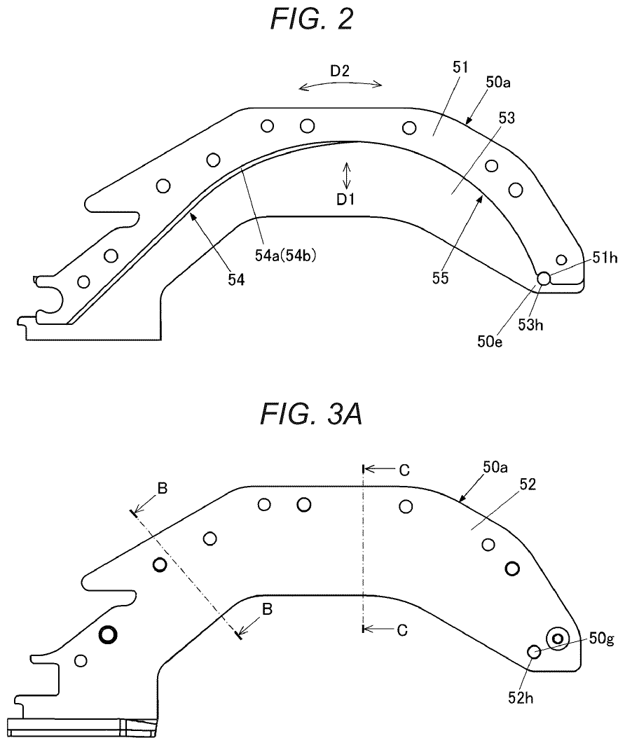

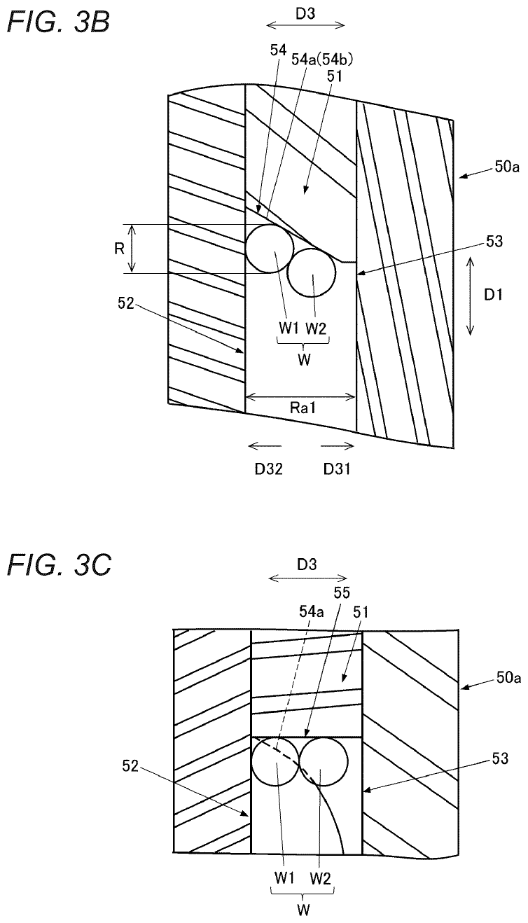

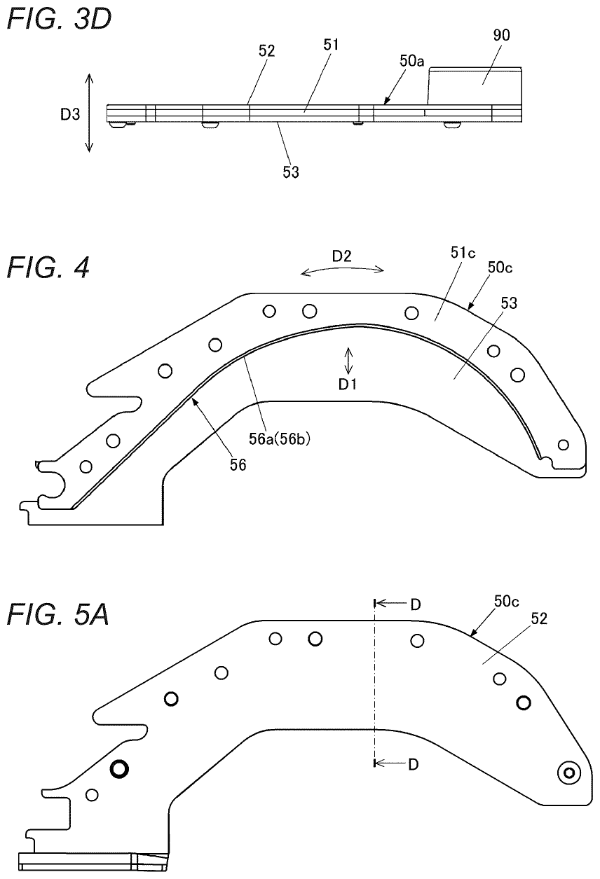

FIG. 2 is a side view showing an example of the curl guide, with some components removed, FIG. 3A is a side view showing the example of the curl guide, FIG. 3B is a cross-sectional view taken along line B-B of FIG. 3A, FIG. 3C is a cross-sectional view taken along line C-C of FIG. 3A, and FIG. 3D is a top view showing the example of the curl guide. FIG. 2 shows a state in which a second wire guide 52 described below is removed. Below, an example of the curl guide 50a will be described with reference to each drawing.

The curl guide 50a includes a first wire guide 51 that regulates positions of the wires W directed toward a radially outer periphery side with respect to a radial direction of the annular feeding path Ru indicated by arrow D1 in FIG. 2, along a circumferential direction of the annular feeding path Ru indicated by arrow D2.

Additionally, the curl guide 50a includes a second wire guide 52 that regulates positions of the wires W directed toward one axial side with respect to an axial direction of the annular feeding path Ru indicated by arrow D3 in FIGS. 3B and 3C, along the circumferential direction of the annular feeding path Ru indicated by arrow D2.

Additionally, the curl guide 50a includes a third wire guide 53 that regulates positions of the wires W directed toward the other axial side with respect to the axial direction of the annular feeding path Ru indicated by arrow D3, along the circumferential direction of the annular feeding path Ru indicated by arrow D2.

In the curl guide 50a, the first wire guide 51 is sandwiched between the second wire guide 52 and the third wire guide 53. The second wire guide 52 protrudes inwardly from the first wire guide 51 along the radial direction of the annular feeding path Ru. The third wire guide 53 protrudes inwardly from the first wire guide 51 along the radial direction of the annular feeding path Ru. Thereby, in the curl guide 50a, the second wire guide 52 and the third wire guide 53 face each other with a spacing corresponding to a thickness of the first wire guide 51. A spacing Ra1 between the second wire guide 52 and the third wire guide 53 is two times or greater a diameter R of the wire W.

Note that the spacing Ra1 between the second wire guide 52 and the third wire guide 53 may be set to about 1.5 times or greater the diameter R of the wire W. Additionally, in order to enable the two wires W to be aligned along the axial direction of the annular feeding path Ru while being in contact with each other, the spacing Ra1 between the second wire guide 52 and the third wire guide 53 is preferably set to about 1.9 times or greater the diameter R of the wire W.

In the curl guide 50a, the first wire guide 51, the second wire guide 52, and the third wire guide 53 are not bent in the axial direction of the annular feeding path Ru indicated by arrow D3, and the entirety of the first wire guide 51, the second wire guide 52, and the third wire guide 53 extends in a straight line shape toward a discharge portion 50e from which the wires W, which are fed in the forward direction by the wire feed portion 3, are fed out. The curl guide 50a includes a guide member 50g at the discharge portion 50e. The guide member 50g has, for example, a cylindrical shape. The second wire guide 52 has a hole portion 52h into which the guide member 50g is press-fitted. The third wire guide 53 has a hole portion 53h into which the guide member 50g is press-fitted. Additionally, the first wire guide 51 has a recessed portion 51h to which the guide member 50g is fitted. In the curl guide 50a, when the first wire guide 51 is sandwiched between the second wire guide 52 and the third wire guide 53, the positions of the hole portion 52h, the hole portion 53h, and the recessed portion 51h are aligned. The guide member 50g passes through the hole portion 52h and the hole portion 53h and is press-fitted into the curl guide 50a, so that a circumferential surface of the guide member 50g is exposed to a guide surface of the first wire guide 51.

The curl guide 50a includes a suppression part 54 that suppresses one of the plurality of wires W, in the present example, one wire W1 of the two wires W, from moving in a direction toward the other wire W2. The suppression part 54, in a width direction of the first wire guide 51 along the axial direction of the annular feeding path Ru indicated by arrow D3, includes a guide portion 54a with varying heights along the radial direction of the annular feeding path Ru indicated by arrow D1.

The guide portion 54a is provided on the first wire guide 51. The guide portion 54a, in the width direction of the first wire guide 51 along the axial direction of the annular feeding path Ru indicated by arrow D3, includes an inclined surface 54b that is inclined in a direction toward an outer side along the radial direction of the annular feeding path Ru indicated by arrow D1, toward the second wire guide 52 on an opposite side to a side on which the reel 20 is offset. Additionally, the guide portion 54a, in the circumferential direction of the annular feeding path Ru indicated by arrow D2, is configured as a concave curved surface or the like along the annular feeding path Ru.

The curl guide 50a includes a parallel guide part 55 that aligns two wires W in parallel and feeds the wires along the axial direction of the annular feeding path Ru indicated by arrow D3. The parallel guide part 55 is provided on the first wire guide 51 on a downstream side of the suppression part 54 with respect to the feeding direction of the wires W, which are fed in the forward direction indicated by arrow F. The parallel guide part 55, in the width direction of the first wire guide 51 along the axial direction of the annular feeding path Ru indicated by arrow D3, is configured as a surface along the axial direction of the annular feeding path Ru. The surface along the axial direction of the annular feeding path Ru is a surface along a direction in which the guide member 50g extends. Additionally, the parallel guide part 55, in the circumferential direction of the annular feeding path Ru indicated by arrow D2, is configured as a concave curved surface or the like along the annular feeding path Ru. In addition, a part of the parallel guide part may be configured by the circumferential surface of the cylindrical guide member 50g.

The height of the suppression part 54 along the radial direction of the annular feeding path Ru indicated by arrow D1 gradually changes toward the parallel guide part 55. That is, the guide portion 54a connects to the parallel guide part 55, with an inclination that gradually decreases from the upstream side toward the downstream side with respect to the feeding direction of the wires W, which are fed in the forward direction indicated by arrow F.

The suppression part 54 is preferably provided within a range of at least ¼ of the annular feeding path Ru in the circumferential direction of the annular feeding path Ru indicated by arrow D2. In addition, the suppression part 54 is preferably provided upstream of the curl guide 50a with respect to the feeding direction of the wires W, which are fed in the forward direction indicated by arrow F. The range in which the guide portion 54a is provided has a length of approximately half of the curl guide 50a in the circumferential direction of the annular feeding path Ru indicated by arrow D2.

### Example of Operational Effects of Curl Guide

In the reinforcing bar binding machine 1A, when the trigger 12 is operated, the feeding motor 31 is driven in the forward rotation direction, and two wires W are fed in the forward direction indicated by arrow F by the wire feeding portion 3.

The two wires W, which are fed in the forward direction by the wire feeding portion 3, are aligned in parallel along the axial direction of the annular feeding path Ru by the wire guide portion 4 on the upstream side of the curl guide 50a.

The two wires W, which are fed in the forward direction, are fed to the curl guide 50a of the curl forming portion 5. The two wires W, by passing through the curl guide 50a, come into contact with the first wire guide 51 and are curled to be wound around the reinforcing bars S along the annular feeding path Ru.

The two wires W wound on the reel 20 are integrally connected at tips by being twisted, crimped, or the like before use, so as to facilitate an operation upon insertion of the wires between the pair of feeding gears 30.

For the two wires W, which are guided to the curl guide 50a, a direction in which they are aligned in parallel is defined by the pair of feeding gears 30 of the wire feeding portion 3 and the wire guide portion 4.

When the spacing Ra1 between the second wire guide 52 and the third wire guide 53 is two times or greater than the diameter of the wire W, the integrally connected tip portions of the two wires W can be inserted between the second wire guide 52 and the third wire guide 53 by an operation in which the wires W are fed by the wire feeding portion 3.

Note that when the spacing Ra1 between the second wire guide 52 and the third wire guide 53 is 1.5 times or greater the diameter of the wire W, the integrally connected tip portions of the two wires W can be inclined with respect to the axial direction of the annular feeding path Ru indicated by arrow D3, and enter between the second wire guide 52 and the third wire guide 53.

The two wires W passing through the curl guide 50a while being aligned in parallel along the axial direction of the annular feeding path Ru indicated by arrow D3 come into contact with the guide portion 54a on the upstream side of the curl guide 50a, as shown in FIG. 3B.

When one wire W1 passing through a side closer to the second wire guide 52 comes into contact with the guide portion 54a during the process of feeding the wires W by the wire feeding portion 3, the wire W1 is suppressed from moving in a direction toward the third wire guide 53 indicated by arrow D31 due to the inclined surface 54b of the guide portion 54a.

Thereby, the one wire W1 is suppressed from moving in the direction toward the other wire W2 passing through a side closer to the third wire guide 53, and the positions of the two wires W are suppressed from being switched between the second wire guide 52 and the third wire guide 53.

In addition, the one wire W1 is subjected to a force that causes the wire to move in a direction toward the second wire guide 52 indicated by arrow D32 due to the inclined surface 54b of the guide portion 54a. When the one wire W1 moves in the direction toward the second wire guide 52 indicated by arrow D32, it comes into contact with the second wire guide 52 and is regulated from moving in the axial direction of the annular feeding path Ru indicated by arrow D3.

When the other wire W2 attempts to move in the direction toward the second wire guide 52 indicated by arrow D32, the other wire W2 comes into contact with the one wire W1. The one wire W1 comes into contact with the second wire guide 52 and is regulated from moving in the axial direction of the annular feeding path Ru indicated by arrow D3. Thereby, the other wire W2 is suppressed from further moving in the direction toward the second wire guide 52 indicated by arrow D32, via the one wire W1.

Accordingly, the other wire W2 is suppressed from moving in the direction toward the one wire W1, and the positions of the two wires W are suppressed from being switched between the second wire guide 52 and the third wire guide 53.

The two wires W passing through the curl guide 50a come into contact with the parallel guide part 55, as shown in FIG. 3C, on the downstream side of the curl guide 50a. The parallel guide part 55 is configured as a surface along the axial direction of the annular feeding path Ru. In addition, the spacing Ra1 between the second wire guide 52 and the third wire guide 53 is two times or greater than the diameter R of the wire W.

Thereby, the two wires W, by passing through the curl guide 50a, are fed without the positions of the two wires W being switched in the annular feeding path Ru by the suppression part 54. In addition, the two wires W are aligned in parallel in the axial direction of the annular feeding path Ru by the parallel guide part 55 and pass through the curl guide 50a.

As described above, one wire W1, by coming into contact with the inclined surface 54b of the guide portion 54a, is suppressed from moving in the direction toward the third wire guide 53 indicated by arrow D31 and from moving in the direction toward the other wire W2. In addition, one wire W1, by coming into contact with the inclined surface 54b of the guide portion 54a, is subjected to a force that causes it to move in the direction toward the second wire guide 52 indicated by arrow D32, and thus can move in the direction of arrow D32 up to a position where it comes into contact with the second wire guide 52. In other words, the suppression part 54 including the guide portion 54a can be regarded as functioning as a guiding part that guides one wire W1 toward the second wire guide 52. The other wire W2, by coming into contact with the inclined surface 54b of the guide portion 54a, is suppressed from moving in the direction toward the third wire guide 53 indicated by arrow D31. In addition, the other wire W2, by coming into contact with the one wire W1, is suppressed from moving in the direction toward the second wire guide 52 indicated by arrow D32, via the one wire W1. Therefore, the one wire W1 and the other wire W2 are suppressed from moving in the axial direction of the annular feeding path Ru indicated by arrow D3. Thereby, within the curl guide 50a, a movable range of the wires W in the left-right direction is reduced. Accordingly, since the positions of the two wires W curled by the curl guide 50a are suppressed from being switched by the operation of feeding the wires W in the forward direction, the positions of the wires W fed out from the curl guide 50a become stable, and an amount of misalignment in the left-right direction is reduced, so that a width dimension required for the induction guide 50b can be suppressed.

Thereby, even when the diameter of the annular feeding path Ru increases, it is possible to feed the plurality of wires W so that the wires enter the induction guide 50b from the curl guide 50a. Accordingly, there is no need to enlarge the induction guide 50b, so that it is possible to suppress increases in size and weight of the reinforcing bar binding machine 1A and a deterioration of operability.

Note that the orientation of the parallel guide part 55 along the axial direction of the annular feeding path Ru indicated by arrow D3 is substantially perpendicular to the plate-shaped member constituting the first wire guide 51, the plate-shaped member constituting the second wire guide 52, and the plate-shaped member constituting the third wire guide 53. The curl guide 50a is provided with the parallel guide part 55 at the discharge portion 50e in the circumferential direction of the annular feeding path Ru indicated by arrow D2, as well as the guide member 50g. Thereby, when press-fitting the guide member 50g into the hole portion 52h of the second wire guide 52, the recessed portion 51h of the first wire guide 51, and the hole portion 53h of the third wire guide 53, a force is applied substantially vertically to the surface of the plate-shaped member constituting the second wire guide 52 and the like. Therefore, it is easy to install the guide member 50g.

In addition, the guide portion 54a, in the width direction of the first wire guide 51 along the axial direction of the annular feeding path Ru indicated by arrow D3, may be configured as an inclined surface that is inclined in a direction toward an outer side along the radial direction of the annular feeding path Ru indicated by arrow D1, toward the third wire guide 53. In other words, the suppression part 54 including the guide portion 54a may function as a guiding part that guides one wire of the plurality of wires toward the third wire guide 53. In addition, the guide portion 54a, in the width direction of the first wire guide 51 along the axial direction of the annular feeding path Ru indicated by arrow D3, may be configured with an inclined surface that is inclined in a direction toward the outer side along the radial direction of the annular feeding path Ru indicated by arrow D1 from a central vicinity toward the second wire guide 52 and an inclined surface that is inclined in a direction toward the outer side along the radial direction of the annular feeding path Ru indicated by arrow D1 from the central vicinity toward the third wire guide 53. In other words, the suppression part 54 including the guide portion 54a may function as a guiding part that guides one of the plurality of wires toward the second wire guide 52 or the third wire guide 53.

### Other Configuration Examples of Curl Guide

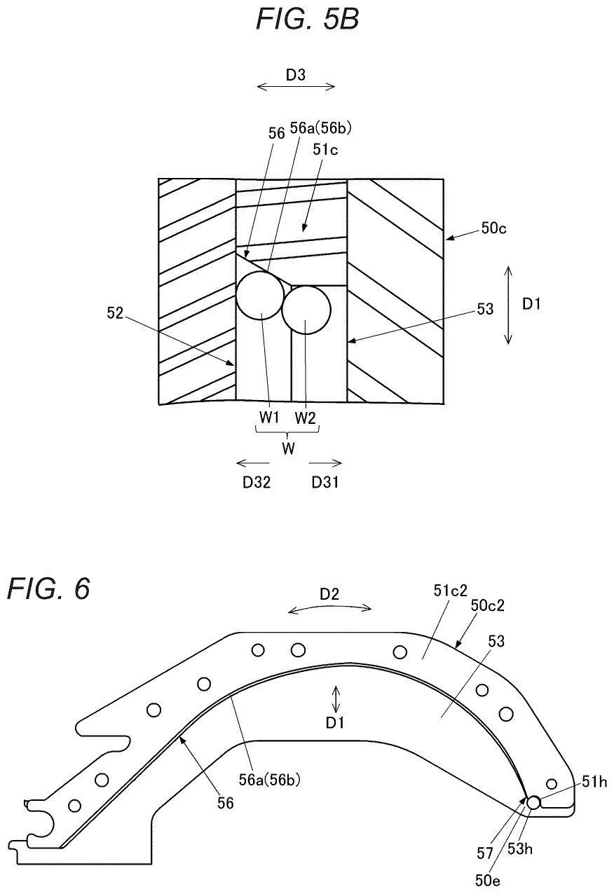

FIG. 4 is a side view showing another example of the curl guide, with some components removed, FIG. 5A is a side view showing another example of the curl guide, and FIG. 5B is a cross-sectional view taken along line D-D of FIG. 5A. FIG. 4 shows a state in which the second wire guide 52 is removed. Below, a curl guide 50c of another example will be described with reference to each drawing.

The curl guide 50c includes a first wire guide 51c that regulates positions of the wires W, which are directed toward the radially outer periphery side with respect to the radial direction of the annular feeding path Ru indicated by arrow D1 in FIG. 4, along the circumferential direction of the annular feeding path Ru indicated by arrow D2.

In the curl guide 50c, the first wire guide 51c is sandwiched between the second wire guide 52 and the third wire guide 53 with respect to the axial direction of the annular feeding path Ru indicated by arrow D3 in FIG. 5B. Thereby, in the curl guide 50c, the second wire guide 52 and the third wire guide 53 face each other with a spacing corresponding to a thickness of the first wire guide 51c. A spacing Ra1 between the second wire guide 52 and the third wire guide 53 is two times or greater the diameter R of the wire W.

The curl guide 50c includes a suppression part 56 that suppresses one of the plurality of wires W, in the present example, one wire W1 of the two wires W, from moving in a direction toward the other wire W2. The suppression part 56, in a width direction of the first wire guide 51c along the axial direction of the annular feeding path Ru indicated by arrow D3, includes a guide portion 56a with varying heights along the radial direction of the annular feeding path Ru indicated by arrow D1.

The guide portion 56a is provided on the first wire guide 51c. The guide portion 56a, in the width direction of the first wire guide 51 along the axial direction of the annular feeding path Ru indicated by arrow D3, is configured with an inclined surface 56b that is inclined in a direction toward the outer side along the radial direction of the annular feeding path Ru indicated by arrow D1, toward the second wire guide 52, over a range of about half of a side closer to at least the second wire guide 52, in the present example, closer to the second wire guide 52. Note that the guide portion 56a may be configured with an inclined surface that is inclined in the direction toward the outer side along the radial direction of the annular feeding path Ru indicated by arrow D1, toward the third wire guide 53, over a range of about half of a side closer to the third wire guide 53. The guide portion 56a, in the circumferential direction of the annular feeding path Ru indicated by arrow D2, is formed with the inclined surface 56b over an entire range. Additionally, the guide portion 56a, in the circumferential direction of the annular feeding path Ru indicated by arrow D2, is configured as a concave curved surface or the like along the annular feeding path Ru.

FIG. 6 is a side view showing a variation of another example of the curl guide, with some components removed. FIG. 6 shows a state in which the second wire guide 52 shown in FIG. 5B and the like is removed. A curl guide 50c2 includes a first wire guide 51c2 that regulates positions of the wires W, which are directed toward the radially outer periphery side with respect to the radial direction of the annular feeding path Ru indicated by arrow D1 in FIG. 6, along the circumferential direction of the annular feeding path Ru indicated by arrow D2. The first wire guide 51c2 includes the suppression part 56 described above, and the suppression part 56 includes a guide portion 56a.

The curl guide 50c2, in the circumferential direction of the annular feeding path Ru indicated by arrow D2, is formed with the guide portion 56a extending up to the vicinity just before the discharge portion 50e of the curl guide 50c2. In addition, the curl guide 50c2 has a parallel guide part 57 formed at the discharge portion 50e.

The parallel guide part 57, in the width direction of the first wire guide 51c along the axial direction of the annular feeding path Ru indicated by arrow D3, is configured as a surface along the axial direction of the annular feeding path Ru.

The guide portion 56a connects to the parallel guide part 57, with an inclination that gradually decreases toward the downstream side with respect to the feeding direction of the wires W, which are fed in the forward direction indicated by arrow F.

As for the operational effects of the curl guide 50c, 50c2, of the two wires W that are fed in the forward direction by the wire feeding portion 3 and pass through the curl guide 50c, 50c2, one wire W1 passing through a side closer to the second wire guide 52 comes into contact with the guide portion 56a, as shown in FIG. 5B. When the one wire W1 comes into contact with the guide portion 56a during the process of feeding the wires W by the wire feeding portion 3, the one wire W1 is suppressed from moving in the direction toward the third wire guide 53 indicated by arrow D31 due to the inclined surface 56b of the guide portion 56a.

Accordingly, the one wire W1 is suppressed from moving in the direction toward the other wire W2, and the positions of the two wires W are suppressed from being switched between the second wire guide 52 and the third wire guide 53.

In addition, the one wire W1 is subjected to a force that causes the wire to move in a direction toward the second wire guide 52 indicated by arrow D32 due to the inclined surface 56b of the guide portion 56a. When the one wire W1 moves in the direction toward the second wire guide 52 indicated by arrow D32, it comes into contact with the second wire guide 52 and is regulated from moving in the axial direction of the annular feeding path Ru indicated by arrow D3.

When the other wire W2 attempts to move in the direction toward the second wire guide 52 indicated by arrow D32, the other wire W2 comes into contact with the one wire W1. The one wire W1 comes into contact with the second wire guide 52 and is regulated from moving in the axial direction of the annular feeding path Ru indicated by arrow D3. Thereby, the other wire W2 is suppressed from further moving in the direction toward the second wire guide 52 indicated by arrow D32, via the one wire W1.

Accordingly, the other wire W2 is suppressed from moving in the direction toward the one wire W1, and the positions of the two wires W are suppressed from being switched between the second wire guide 52 and the third wire guide 53.

Accordingly, the two wires W, by passing through the curl guide 50c, 50c2, are guided in a state in which their positions are suppressed from being switched in the axial direction of the annular feeding path Ru by the suppression part 56.

As described above, one wire W1, by coming into contact with the inclined surface 56b of the guide portion 56a, is suppressed from moving in the direction toward the third wire guide 53 indicated by arrow D31 and from moving in the direction toward the other wire W2. In addition, one wire W1, by coming into contact with the inclined surface 56b of the guide portion 56a, is subjected to a force that causes it to move in the direction toward the second wire guide 52 indicated by arrow D32, and thus can move in the direction of arrow D32 up to a position where it comes into contact with the second wire guide 52. In other words, the suppression part 56 including the guide portion 56a can be regarded as functioning as a guiding portion that guides one wire W1 toward the second wire guide 52. The other wire W2, by coming into contact with the one wire W1, is suppressed from moving in the direction toward the second wire guide 52 indicated by arrow D32. Therefore, the one wire W1 and the other wire W2 are suppressed from moving in the axial direction of the annular feeding path Ru indicated by arrow D3. Thereby, within the curl guide 50c, 50c2, a movable range of the wires W in the left-right direction is reduced. Accordingly, since the positions of the two wires W curled by the curl guide 50c, 50c2 are suppressed from being switched by the operation of feeding the wires W in the forward direction, the positions of the wires W fed out from the curl guide 50c, 50c2 become stable, and an amount of misalignment in the left-right direction is reduced, so that a width dimension required for the induction guide 50b can be suppressed. Note that the suppression part 56 including the guide portion 56a may function as a guiding part that guides one wire of the plurality of wires toward the third wire guide 53.

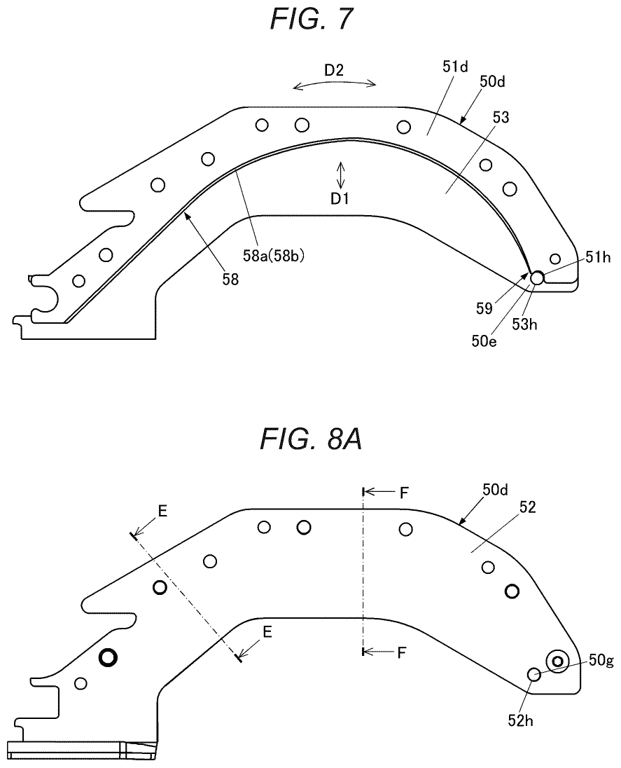

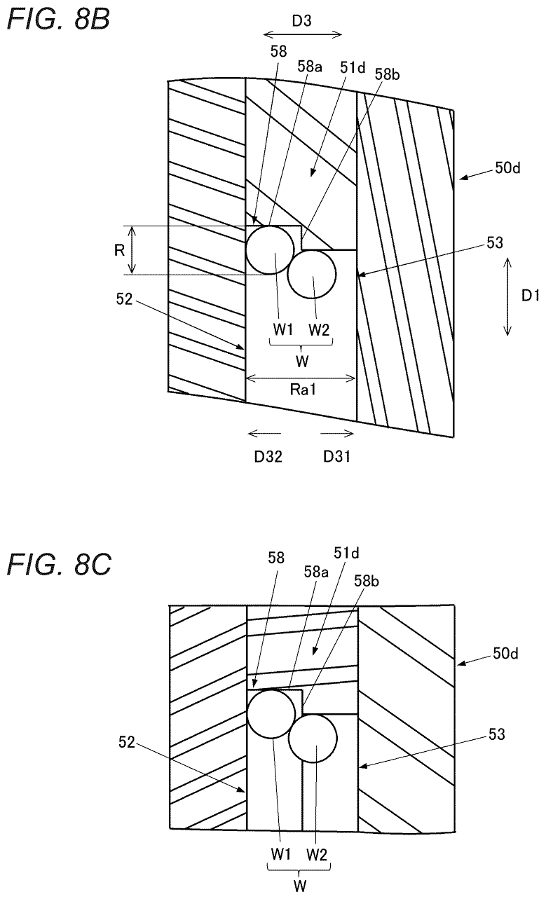

FIG. 7 is a side view showing still another example of the curl guide, with some components removed, FIG. 8A is a side view showing still another example of the curl guide, FIG. 8B is a cross-sectional view taken along line E-E of FIG. 8A, and FIG. 8C is a cross-sectional view taken along line F-F of FIG. 8A. FIG. 7 shows a state in which the second wire guide 52 is removed. Below, a curl guide 50d of still another example will be described with reference to each drawing.

The curl guide 50d includes a first wire guide 51d that regulates positions of the wires W, which are directed toward the radially outer periphery side with respect to the radial direction of the annular feeding path Ru indicated by arrow D1 in FIG. 7, along the circumferential direction of the annular feeding path Ru indicated by arrow D2.

In the curl guide 50d, the first wire guide 51d is sandwiched between the second wire guide 52 and the third wire guide 53 with respect to the axial direction of the annular feeding path Ru indicated by arrow D3 in FIG. 8B. Thereby, in the curl guide 50d, the second wire guide 52 and the third wire guide 53 face each other with a spacing corresponding to a thickness of the first wire guide 51d. A spacing Ra1 between the second wire guide 52 and the third wire guide 53 is two times or greater than the diameter R of the wire W.

The curl guide 50d includes a suppression part 58 that suppresses one of the plurality of wires W, in the present example, one wire W1 of the two wires W, from moving in the axial direction of the annular feeding path. The suppression part 58, in a width direction of the first wire guide 51d along the axial direction of the annular feeding path Ru indicated by arrow D3, includes a guide portion 58a with varying heights along the radial direction of the annular feeding path Ru indicated by arrow D1.

The guide portion 58a is provided on the first wire guide 51d. The guide portion 58a includes a vertical wall 58b facing the second wire guide 52. In order to form the vertical wall 58b, the guide portion 58a is provided with a step on a side closer to the second wire guide 52 in the width direction of the first wire guide 51 along the axial direction of the annular feeding path Ru indicated by arrow D3, the step having a concave shape in the direction toward the outer side along the radial direction of the annular feeding path Ru indicated by arrow D1 and accommodating one wire W1. The guide portion 58a is a step with a width along the axial direction of the annular feeding path Ru indicated by arrow D3, which is slightly larger than the diameter R of the wire W, and a depth along the radial direction of the annular feeding path Ru indicated by arrow D1, which is about half the diameter R of the wire W. Thereby, the vertical wall 58b faces the second wire guide 52 with a spacing equal to or greater than the diameter of the wire W. Additionally, the guide portion 58a, in the circumferential direction of the annular feeding path Ru indicated by arrow D2, is configured as a concave curved surface or the like along the annular feeding path Ru. In the guide portion 58a, in the circumferential direction of the annular feeding path Ru indicated by arrow D2, the vertical wall 58b is formed up to the vicinity of the discharge portion 50e of the curl guide 50d.

The curl guide 50d has a parallel guide part 59 formed at the discharge portion 50e.

The parallel guide part 59, in the width direction of the first wire guide 51d along the axial direction of the annular feeding path Ru indicated by arrow D3, is configured as a surface along the axial direction of the annular feeding path Ru.

The guide portion 58a connects to the parallel guide part 59, with a height of the vertical wall 58b gradually decreasing toward the downstream side with respect to the feeding direction of the wires W, which are fed in the forward direction indicated by arrow F.

As for the operational effects of the curl guide 50d, of the two wires W that are fed in the forward direction by the wire feeding portion 3 and pass through the curl guide 50d, one wire W1 passing through a side closer to the second wire guide 52 enters the guide portion 58a, as shown in FIG. 8B. When the one wire W1 enters the guide portion 58a during the process of feeding the wires W, the one wire W1 is suppressed from moving in the direction toward the third wire guide 53 indicated by arrow D31 due to the vertical wall 58b of the guide portion 58a. Accordingly, the one wire W1 is suppressed from moving in the direction toward the other wire W2, and the positions of the two wires W are suppressed from being switched between the second wire guide 52 and the third wire guide 53.

In addition, when the one wire W1 attempts to move in the direction toward the second wire guide 52 indicated by arrow D32, the one wire W1 is regulated from moving in the axial direction of the annular feeding path Ru indicated by arrow D3 if the one wire W1 comes into contact with the second wire guide 52.

When the other wire W2 attempts to move in the direction toward the second wire guide 52 indicated by arrow D32, the other wire W2 comes into contact with the one wire W1. The one wire W1 comes into contact with the second wire guide 52 and is regulated from moving in the axial direction of the annular feeding path Ru indicated by arrow D3. Thereby, the other wire W2 is suppressed from further moving in the direction toward the second wire guide 52 indicated by arrow D32, via the one wire W1.

Accordingly, the other wire W2 is suppressed from moving in the direction toward the one wire W1, and the positions of the two wires W are suppressed from being switched between the second wire guide 52 and the third wire guide 53.

The two wires W, by passing through the curl guide 50d, are guided in a state in which their positions are suppressed from being switched in the axial direction of the annular feeding path Ru by the suppression part 58.

In addition, as described above, the one wire W1, by coming into contact with the vertical wall 58b of the guide portion 58a, is suppressed from moving in the direction toward the third wire guide 53 indicated by arrow D31 and from moving in the direction toward the other wire W2. Additionally, the one wire W can move in the direction toward the second wire guide 52 indicated by arrow D32 until it comes into contact with the second wire guide 52. The other wire W2, by coming into contact with the one wire W1, is suppressed from moving in the direction toward the second wire guide 52 indicated by arrow D32. Therefore, the one wire W1 and the other wire W2 are suppressed from moving in the axial direction of the annular feeding path Ru indicated by arrow D3. Thereby, within the curl guide 50d, a movable range of the wires W in the left-right direction is reduced. Accordingly, the positions of the two wires W curled by the curl guide 50d are suppressed from being switched by the operation of feeding the wires W in the forward direction, and an amount of misalignment in the left-right direction of the wires W fed out from the curl guide 50d is reduced, so that a width dimension required for the induction guide 50b can be suppressed.

As described above, an aspect of the present disclosure is a binding machine including: a wire feeding portion configured to feed a plurality of wires; a curl forming portion configured to form an annular feeding path for winding the plurality of wires fed by the wire feeding portion around a to-be-bound object; and a binding portion configured to twist the plurality of wires wound on the to-be-bound object. The curl forming portion includes a curl guide configured to curl the plurality of wires fed by the wire feeding portion, and an induction guide configured to guide the plurality of wires curled by the curl guide to the binding portion. The curl guide includes a first wire guide configured to regulate positions of the wires directed toward a radially outer periphery side with respect to a radial direction of the annular feeding path, a second wire guide configured to regulate positions of the wires directed toward one axial side with respect to an axial direction of the annular feeding path, and a third wire guide configured to regulate positions of the wires directed toward the other axial side. The curl guide includes a suppression part configured to allow the plurality of wires to be aligned in contact with each other between the second wire guide and the third wire guide along the axial direction of the annular feeding path, and to suppress one wire of the plurality of wires from moving in a direction toward another wire.

In the present disclosure, one wire of a plurality of wires, which are fed to the curl forming portion by the wire feeding portion and aligned between the second wire guide and the third wire guide along the axial direction of the annular feeding path, is suppressed by the suppression part from moving in the direction toward another wire.

In the present disclosure, by suppressing one wire of the plurality of wires aligned between the second wire guide and the third wire guide from moving in the direction toward another wire, it is possible to suppress the order of alignment of the plurality of wires aligned along the axial direction of the annular feeding path from being switched. This can stabilize the posture of the wires in the air after being fed out from the curl guide. Therefore, even when the diameter of the annular feeding path increases, it is possible to feed the plurality of wires so that the wires enter the induction guide from the curl guide, without enlarging the induction guide. Accordingly, it is possible to suppress increases in size and weight of the binding machine and a deterioration of operability.

According to the present disclosure, it is possible to provide a binding machine that can suppress one of a plurality of wires from moving in a direction toward another wire in a curl guide.

What is claimed is:

1. A binding machine comprising:
a wire feeding portion configured to feed a plurality of wires;
a curl forming portion configured to form an annular feeding path for winding the plurality of wires fed by the wire feeding portion around a to-be-bound object; and
a binding portion configured to twist the plurality of wires wound on the to-be-bound object, wherein
the curl forming portion comprises
a curl guide configured to curl the plurality of wires fed by the wire feeding portion, and
an induction guide configured to guide the plurality of wires curled by the curl guide to the binding portion,
the curl guide comprises a first wire guide configured to regulate positions of the wires directed toward a radially outer periphery side with respect to a radial direction of the annular feeding path, a second wire guide configured to regulate positions of the wires directed toward one axial side with respect to an axial direction of the annular feeding path, and a third wire guide configured to regulate positions of the wires directed toward the other axial side, and
the curl guide comprises a suppression part configured to allow the plurality of wires to be aligned in contact with each other between the second wire guide and the third wire guide along the axial direction of the annular feeding path, and to suppress one wire of the plurality of wires from moving in a direction toward another wire.

2. The binding machine according to claim 1, wherein the suppression part comprises a guide portion with varying heights along the radial direction of the annular feeding path, in a width direction of the first wire guide along the axial direction of the annular feeding path.

3. The binding machine according to claim 1, wherein the curl guide is configured to suppress the other wire from moving in a direction toward the one wire, via the one wire whose movement is suppressed by the suppression part.

4. The binding machine according to claim 2, wherein the guide portion comprises an inclined surface that is inclined in a direction toward an outer side along the radial direction of the annular feeding path, in a width direction of the first wire guide along the axial direction of the annular feeding path.

5. The binding machine according to claim 4, wherein the guide portion comprises the inclined surface that is inclined in the direction toward the outer side along the radial direction of the annular feeding path, on a side closer to the second wire guide, on a side closer to the third wire guide, or on both of the side closer to the second wire guide and the side closer to the third wire guide, in the width direction of the first wire guide along the axial direction of the annular feeding path.

6. The binding machine according to claim 2, wherein the guide portion comprises a step along the radial direction of the annular feeding path, in the width direction of the first wire guide along the axial direction of the annular feeding path.

7. The binding machine according to claim 6, wherein the guide portion comprises a vertical wall facing the second wire guide.

8. The binding machine according to claim 2, wherein the suppression part is formed on the first wire guide along a circumferential direction of the annular feeding path.

9. The binding machine according to claim 8, wherein the suppression part is provided on an upstream side of the curl guide with respect to a feeding direction of the wires fed in a forward direction by the wire feeding portion.

10. The binding machine according to claim 9, wherein the suppression part is provided within a range of at least ¼ of the annular feeding path in the circumferential direction of the annular feeding path.

11. The binding machine according to claim 9, wherein the curl guide comprises a parallel guide part configured by a surface along the axial direction of the annular feeding path, on a downstream side of the suppression part with respect to the feeding direction of the wires fed in the forward direction by the wire feeding portion.

12. The binding machine according to claim 11, wherein the suppression part has a height along the radial direction of the annular feeding path, which gradually changes toward the parallel guide part.

13. A binding machine comprising:
a wire feeding portion configured to feed a plurality of wires;
a curl forming portion configured to form an annular feeding path for winding the plurality of wires fed by the wire feeding portion around a to-be-bound object; and
a binding portion configured to twist the plurality of wires wound on the to-be-bound object, wherein
the curl forming portion comprises
a curl guide configured to curl the plurality of wires fed by the wire feeding portion, and
an induction guide configured to guide the plurality of wires curled by the curl guide to the binding portion,
the curl guide comprises a first wire guide configured to regulate positions of the wires directed toward a radially outer periphery side with respect to a radial direction of the annular feeding path, a second wire guide configured to regulate positions of the wires directed toward one axial side with respect to an axial direction of the annular feeding path, and a third wire guide configured to regulate positions of the wires directed toward the other axial side, and
the curl guide comprises a guiding part configured to allow the plurality of wires to be aligned in contact with each other between the second wire guide and the third wire guide along the axial direction of the annular feeding path, and to guide one wire of the plurality of wires toward the second wire guide or the third wire guide.

14. A binding machine comprising:
a wire feeding portion configured to feed a plurality of wires;
a curl forming portion configured to form an annular feeding path for winding the plurality of wires fed by the wire feeding portion around a to-be-bound object; and
a binding portion configured to twist the plurality of wires wound on the to-be-bound object, wherein
the curl forming portion comprises
a curl guide configured to curl the plurality of wires fed by the wire feeding portion, and
an induction guide configured to guide the plurality of wires curled by the curl guide to the binding portion,
the curl guide comprises a first wire guide configured to regulate positions of the wires directed toward a radially outer periphery side with respect to a radial direction of the annular feeding path, a second wire guide configured to regulate positions of the wires directed toward one axial side with respect to an axial direction of the annular feeding path, and a third wire guide configured to regulate positions of the wires directed toward the other axial side, and
the curl guide comprises a suppression part configured to allow the plurality of wires to be aligned in contact with each other between the second wire guide and the third wire guide along the axial direction of the annular feeding path, and comprising a step along the radial direction of the annular feeding path, in a width direction of the first wire guide along the axial direction of the annular feeding path.
